(19) United States
(12) Patent Application Publication
(10) Pub. No.: US 2018/0195902 A1
(43) Pub. Date: Jul. 12, 2018

(54) TITLED FILTER IMAGING SPECTROMETER

(71) Applicant: Michigan Aerospace Corporation, Ann Arbor, MI (US)

(72) Inventor: Paul Bryon HAYS, Ann Arbor, MI (US)

(21) Appl. No.: 15/865,446

(22) Filed: Jan. 9, 2018

Related U.S. Application Data
(60) Provisional application No. 62/443,957, filed on Jan. 9, 2017.

(51) Int. Cl. G01J 3/02; G01N 21/64; G01J 3/44; G01J 3/26

(52) U.S. Cl. CPC G01J 3/0229; G01N 21/6456; G01N 2021/6471; G01J 3/26; G01J 3/0208; G01J 3/4406

(57) ABSTRACT

A Tilted Filter Imaging Spectrometer (TFIS) is designed to be a very small optical spectrometer having very high sensitivity and spectral resolution. These properties suggest the use of the device as a Fraunhofer Line discriminator (FLD) to detect objects that fluoresce in sunlight. According to at least one embodiment of the present invention, the tilted filter imaging spectrometer incorporates at least one dielectric filter, at least one imaging lens structure; and an imaging detector operatively positioned at a focal length of the imaging lens structure, wherein the dielectric filter is operatively positioned at an angle relative to an optical axis of the imaging lens structure. In at least a second embodiment, the tilted filter imaging spectrometer further incorporates at least one Fabry-Perot Etalon, wherein the Fabry Perot Etalon and the dielectric filter are operatively positioned at angles relative to an optical axis of the imaging lens structure.

### BACKGROUND OF THE INVENTION

### Summary of the Invention

The present invention is directed to a Tilted Filter Imaging Spectrometer (TFIS), which is designed to be a very small optical spectrometer having very high sensitivity and high spectral resolution. These properties suggest the use of the device as a Fraunhofer Line discriminator (FLD) to detect objects that fluoresce in sunlight.

### DISCUSSION OF THE PRIOR ART

An optical instrument called the Fraunhofer line discriminator (FLD) was built by the U.S. Geological Survey (Stoertz, 1969, Placyk, 1975 and Placyk & Gabriel, 1975) to examine fluorescent phenomena that can be used in identifying mineral deposits, plant fluorescence (Watson et al., 1974), fluorescent die tracking of water masses (Stoetz, 1969, Watson et al., 1974), and fluorescent industrial and natural wastes (Watson et al., 1974). The concept Stoertz and Placyk introduced was to use the known Fraunhofer lines in the solar spectrum to determine the reflected sunlight, which when subtracted from the total light is the fluorescence. The details of the technique are described in a paper discussing sunlight-induced chlorophyll fluorescence (J. Louis et. al., 2005). Since this early work, there have been numerous experiments to measure plant fluorescence using interferometers and spectrometers, the most recent observations have been made using instruments on the Greenhouse Gases Observing Satellite (GOSAT) and the Orbiting Carbon Observatory (OCO) (Crisp et al., 2008). Both these satellites carry very large and expensive Fourier Transform Spectrometers (FTS) that allow the FLD measurements of plant fluorescence. The GOSAT FTS been used to produce global maps of plant fluorescence (Joiner et al., 2011) and the OCO FTS has been used to produce similar maps. An entire satellite devoted to fluorescence measurements, Fluorescence Explorer (FLEX) has been started by the European Space Agency. The cost of these large missions begs for a more modest approach.

### SUMMARY OF THE INVENTION

With the present invention, we will show that a very simple spectral imaging device can make fluorescence observations that can compete with these large and costly instruments. A dielectric interference filter is in reality a very small Fabry-Perot interferometer (Born & Wolf, 1970) with a cavity material having a fairly high index of refraction. The basic characteristic of these devices is that a narrow spectral region is transmitted through the filter. The wavelength that is transmitted depends on the angle at which the collimated beam strikes the filter.

According to at least one embodiment of the present invention, a tilted filter imaging spectrometer of the present invention comprises at least one dielectric filter; at least one imaging lens structure; and an imaging detector operatively positioned at a focal length of the at least one imaging lens structure, wherein the at least one dielectric filter is operatively positioned at an angle relative to an optical axis of the at least one imaging lens structure.

In at least a second embodiment, a tilted filter imaging spectrometer of the present invention comprises at least one dielectric filter; at least one Fabry-Perot Etalon: at least one imaging lens structure; and an imaging detector operatively positioned at a focal length of the at least one imaging lens structure, wherein the at least one Fabry Perot Etalon and at least one dielectric filter that are operatively positioned at angles relative to an optical axis of the at least one imaging lens structure.

In a further embodiment, the present invention is also directed to a method for tilted filter imaging, comprising the steps of: providing a tilted filter imaging spectrometer having at least one dielectric filter, at least one imaging lens structure and an imaging detector operatively positioned at a focal length of the at least one imaging lens structure; variably positioning the at least one dielectric filter at an angle relative to an optical axis of the at least one imaging lens structure; and scanning an area to be studied wherein light reflected from the area to be studied is filtered through the at least one dielectric filter, imaging the filtered light from the at least one dielectric filter via the imaging lens structure to the imaging detector; and generating a fluorescence spectrum of the area to be studied via the filtered light detected by the imaging detector.

### BRIEF DESCRIPTION OF THE DRAWINGS

The present invention is illustrated in the accompanying drawings, wherein:

FIG. 1a illustrates the transmission of a dielectric filter when illuminated by monochromatic light at the center wavelength of the filter,

FIG. 1b illustrates the transmission of a dielectric filter when illuminated by monochromatic light along a line at y=0;

FIG. 2a shows the transmission pattern of the filter for monochromatic light at a somewhat lower wavelength;

FIG. 2b shows the transmission pattern of the filter for monochromatic light at a somewhat lower wavelength along a line at y=0;

FIG. 3a shows the transmission pattern wherein the filter is tilted at an angle whereby the conical ring becomes an arc like pattern of transmission;

FIG. 3b shows the transmission pattern wherein the filter is tilted at an angle whereby the conical ring becomes an arc like pattern of transmission along a line at y=0;

FIG. 4 shows the solar spectrum near the H alpha Fraunhofer line;

FIG. 5a at the top shows a simulation of sunlight in the 652-660 nm region being reflected from a white surface and viewed through a 0.08 nm single high index cavity filter that is tilted at an angle of 5.7 degrees;

FIG. 5b at the bottom shows the true solar spectrum as the thin line and the spectrum taken on the y=0 line across the detector as small crosses;

FIG. 6 shows a side view of a first embodiment or implementation of the present invention, using a single filter tilted with respect to the optical axis of the camera;

FIG. 7 shows a side view of an example of dual channel TFIS optics for the present invention where two telescopes or channels are focused on a single detector device;

FIG. 8 shows a front view of an example of four channel optics for the present invention where four different spectral regions can be viewed on the single detector;

FIG. 9 shows a side view of a further embodiment of the present invention with the addition of a high resolution Fabry-Perot etalon to the optical system of the present invention;

FIG. 10 shows how a TFIS spectral imager can sequentially sample the spectrum across a scene as the imager moves;

FIG. 11 illustrates how the present invention can be used as a pushbroom spectral scanner collecting detailed spectral information which can be analyzed using the FLD technique to produce maps of reflectance and fluorescence of the Earth; and

FIG. 12 shows how a stationary scene can be analyzed for the spectral information over a fixed field by taking images of the scene as the filter is tilted.

### DETAILED DESCRIPTION OF THE INVENTION

The embodiments of the present invention will be described hereinbelow in conjunction with the above-described drawings. The present invention as embodied in an instrument that implements the Tilted Filter Imaging Spectrometer (TFIS). A dielectric interference filter is in reality a very small Fabry-Perot interferometer (Born & Wolf, 1970) with a cavity of material having a fairly high index of refraction. The basic characteristic of these devices is that a narrow spectral region is transmitted through the filter. The wavelength that is transmitted depends on the angle at which the collimated beam strikes the filter, as expressed in the following formula:

$${λ}_{θ} = {λ}_{o} \sqrt{1 - \frac{{sin ( θ )}^{2}}{{μ}_{s}^{2}}}$$

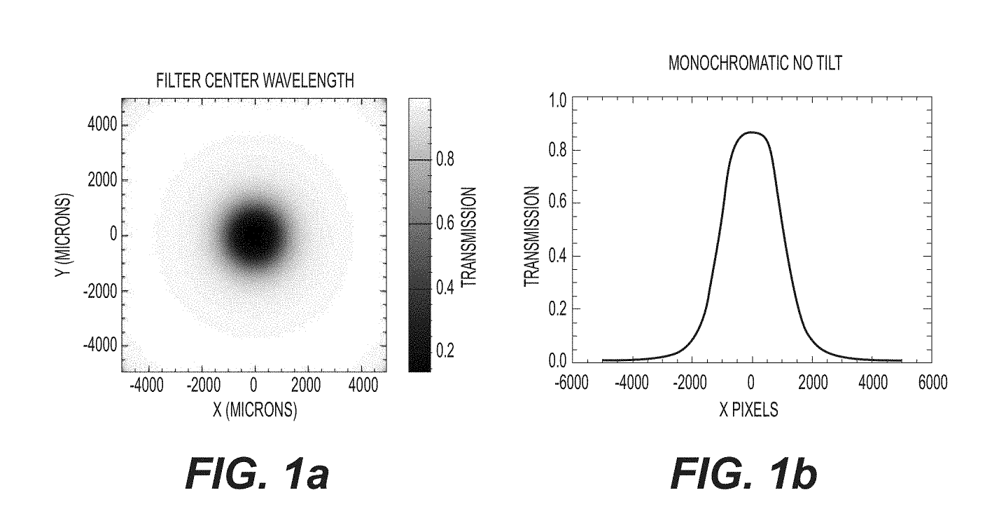

Here λ_{θ} is the wavelength of light transmitted at an angle θ through the filter with spacer index μₛ. At normal incidence, the wavelength transmitted is λₒ. In most cases, a fairly wide cone of light normal to the surface is detected by a photodetector in the center of the fringe pattern. This is illustrated in FIGS. 1a and 1b where a monochromatic light floods the filter at the wavelength. In FIGS. 1a-1b, transmission is represented as a function of angle through the filter. Specifically, FIG. 1a illustrates a graphical representation of the transmission of the dielectric filter when illuminated by monochromatic light at the center wavelength of the filter. An imaging detector detecting the monochromatic light through the dielectric filter is in effect sampling light at varying angles through the filter, the center being light that is striking the filter structure at exactly 90 degrees. FIG. 1b illustrates a graph of the transmission along a line at y=0.

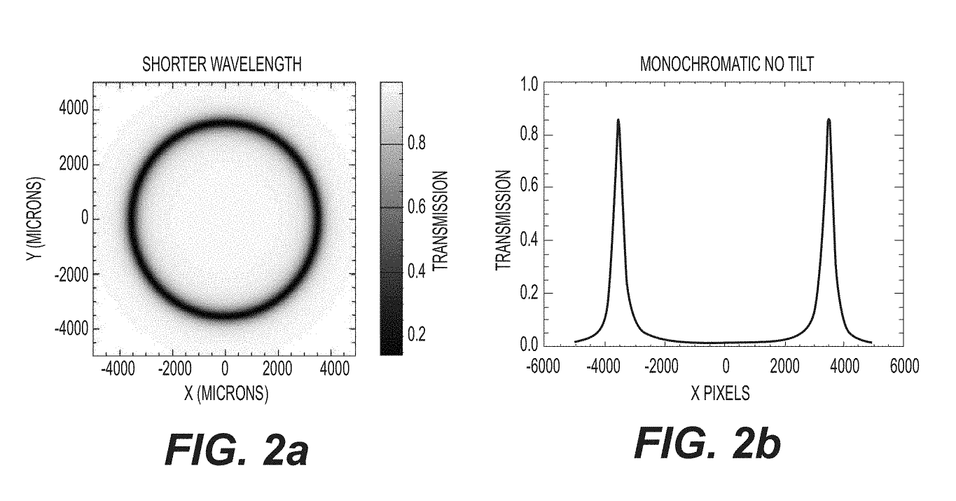

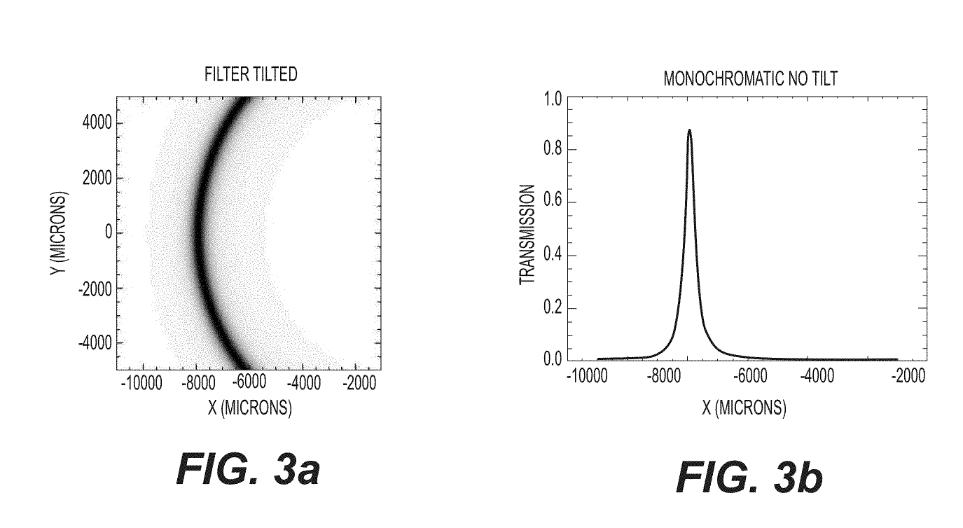

However, if the wavelength of the light is decreased, this pattern changes from a central Gaussian-like bump to a conical ring of transmission as shown in FIGS. 2a-2b. In particular, FIG. 2a shows a graphical representation of the transmission pattern of the filter for monochromatic light at a somewhat lower wavelength. The transmission pattern shifts from the central Gaussian-like pattern to a conical ring. FIG. 2b shows a graph representing the transmission along a line at y=0. As the wavelength is decreased, the ring expands and narrows. The actual width of the spectral line does not change very much until the angle become very large. At large angles greater than 15 degrees in high index filters, the two polarizations do start to separate increasing the filter width (Swenson, 1975). If the filter is tilted at an angle, the ring becomes an are as shown in FIGS. 3a-3b.

FIG. 3a shows a graphical representation of the transmission pattern wherein the filter is tilted at an angle whereby the conical ring becomes an arc-like pattern of transmission. FIG. 3b illustrates a graph showing the transmission along a line at y=0.

It becomes obvious that there is a clear analog to a grating spectrometer where here the spectra are distributed arcs; however, there is one considerable difference. A dielectric filter is a Fabry-Perot interferometer and it has the famous Jacquinot's Advantage where the throughput of an interferometer with the same resolution as a spectrometer can transmit from 30 to 50 times as much energy. To implement the FLD technique for detecting reflectance and fluorescence, one must have an instrument that can measure the properties of the Fraunhofer line in the reflected light with a high degree of accuracy. The reflected light is calculated by multiplying the depth of the darkened line by the known ratio of continuum to line depth.

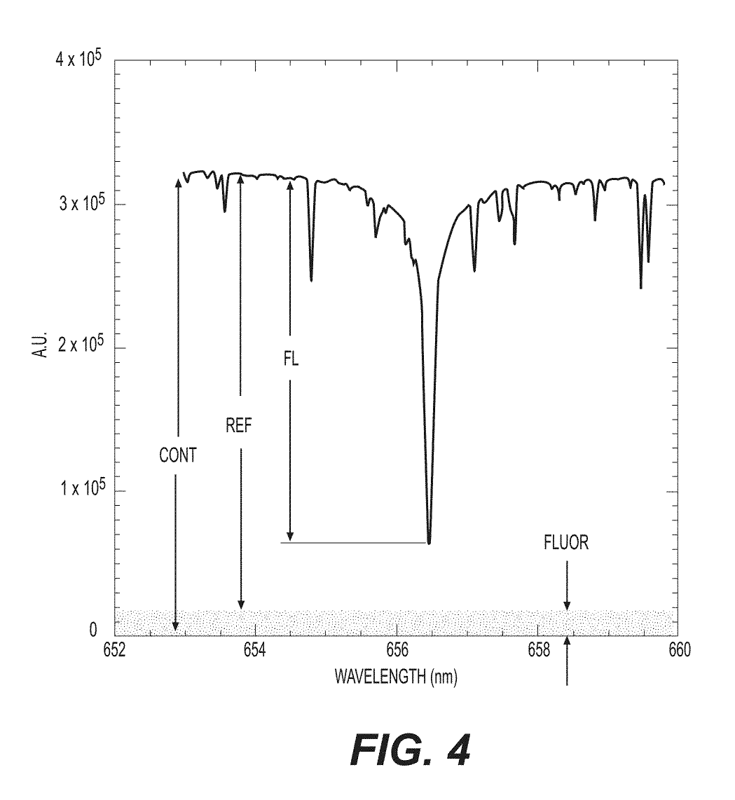

FIG. 4 shows the solar spectrum near the H alpha Fraunhofer line, wherein the numerous smaller solar absorption lines are shown surrounding the strong H alpha line. Here also are shown the basic measurements required to calculate the reflectance and fluorescence. In FIG. 4, these quantities are FL for the measured Fraunhofer line depth and CONT for the measured continuum. The fluorescence is simply the total measured signal in the continuum CONT. The ratio R_{fl}=Ref/FL in the solar spectrum is well known, thus the fluorescence is simply the difference where FLUOR=CONT−R_{fl}*FL (Plascyk, 1975).

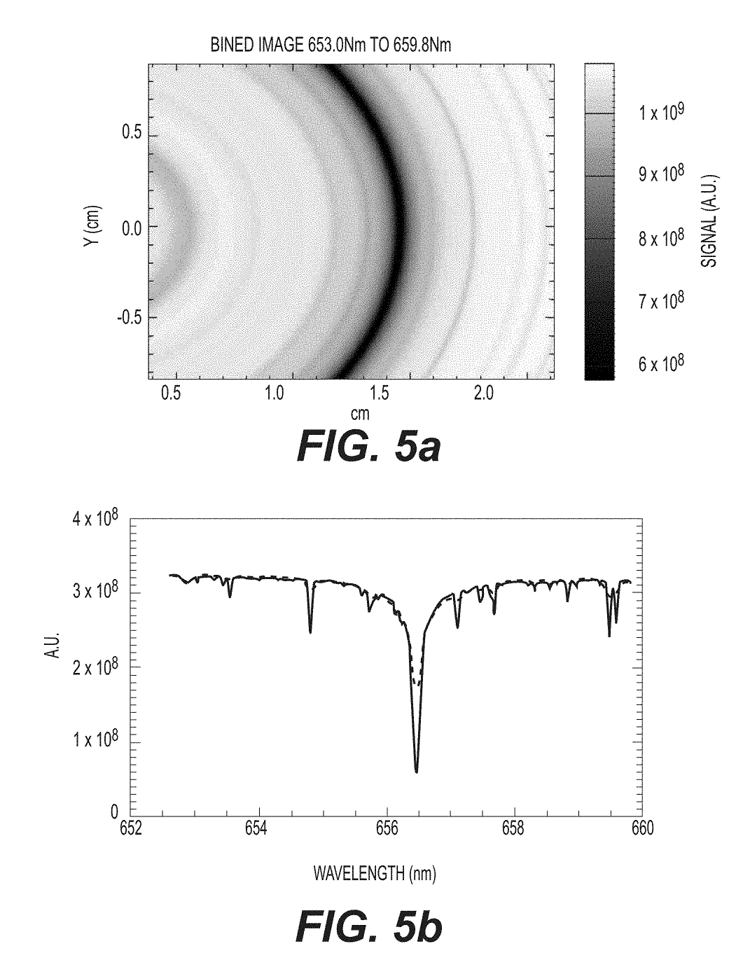

FIG. 5a at the top shows a simulation of sunlight in the 652-660 nm region being reflected from a white surface and viewed through a 0.08 nm single high index cavity filter that is tilted at an angle of 5.7 degrees. FIG. 5b at the bottom shows the true solar spectrum as the thin line and the spectrum taken on the y=0 line across the detector as small crosses, note the slight broadening due to the spectral width of the filter. FIGS. 5a-5b show that the present invention will make a spectrum of high quality that can be used to measure the underlying fluorescence and the total reflectance of a body being illuminated by sunlight, wherein the line shown in the drawings is the H alpha Fraunhofer line. Some broadening is caused by the finite resolution of the filter used in the implementation of the invention.

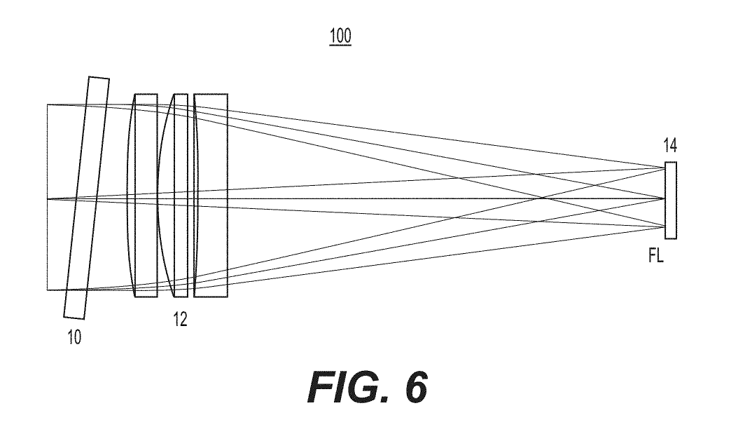

FIG. 6 shows a first example implementation of the present invention, wherein a single dielectric filter is tilted with respect to the optical axis of the camera. The light reaching each point on the detector has passed through the filter at a single angle and is a sample at nearly a single wavelength. As shown in FIG. 6, at least a first embodiment 100 of the present invention comprises a filter structure 10 that consists of one or more dielectric filters, an imaging lens system 12, and imaging detector 14 placed at the focal length FL of the lens system.

As noted above, in this implementation, the filter structure 10 uses a single filter. High quality optics are important since aberrations will cause the light being viewed by a single pixel on the detector 14 to pass through the filter structure 10 in a fashion that broadens the spectral bandpass of the filter structure 10. This being especially true at larger angles through the filter structure 10. The filter structure 10 are arranged at an angle to the optical axis φ of the lens system 12. This angle φ can be fixed or can be scanned creating either a fixed fringe pattern on the detector 14 or a moving or scanning fringe pattern. The angle of the filter structure 10 must be known accurately in order to calibrate the spectrum being viewed by the detector 14. If the filter structure 10 is being scanned in angle, the integration time and scan rate must be such that the spectrum is not smeared significantly during the integration period. Similarly, if the filter angle is fixed and the scene is scanned as the TFIS is moved, again integration time and scene motion must be such that the spectrum is not significantly broadened.

The first embodiment shown in FIG. 6 is a very elementary version of the TFIS using a linear optical configuration. As the filter structure 10 is tilted from flat to a higher angle, the fringe pattern configured as in FIG. 6 would slide from the top toward the bottom of the detector 14 as illustrated in FIGS. 5a-5b. Alternatively, if the filter structure 10 is fixed and the scene is moved across the detector 14 from the top toward the bottom every point on the scene would have collected a spectrum.

As discussed above, the detector 14 receives the light filtered via the dielectric filter in the form of a fringe pattern that is then used to generate a fluorescence spectrum. It is to be understood that the imaging detector of every embodiment of the present invention includes the necessary hardware (not shown), including data processing circuitry, memory, data input devices, data display devices, operating software, signal processing software and data calculating software, to generate data representing or relating to a fluorescence spectrum, as would be understood by those of skill in the art.

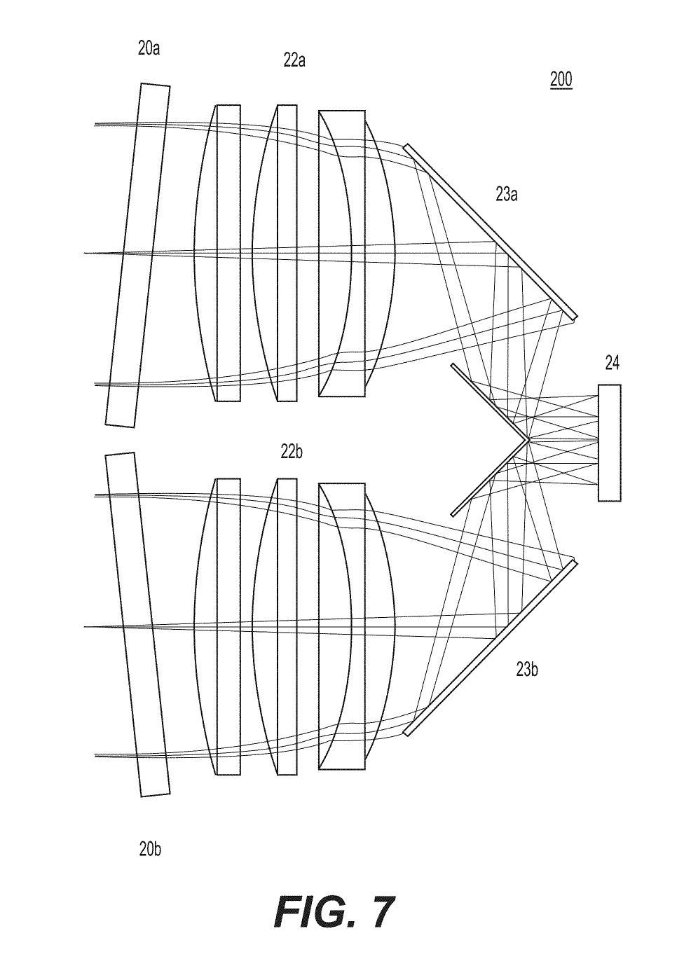

FIG. 7 shows a second embodiment of the present invention, wherein the TFIS instrument 200 is implemented using dual channel optics. In this embodiment, the instrument 200 incorporates filter structures 20a,20b each of which consists of one or more dielectric filters, imaging lens systems 22a,22b, mirrors 23a,23b, and a single imaging detector 24. In this embodiment, there can be two different wavelength regions viewed through the two filter structures 20a,20b.

In FIG. 7, the basic linear TFIS configuration has been bent in such a fashion that two optical systems can be combined to allow two spectral regions to be detected simultaneously on the same image detector. Again, the filters could be held at a fixed angle or can be scanned to create a moving fringe pattern on the detector.

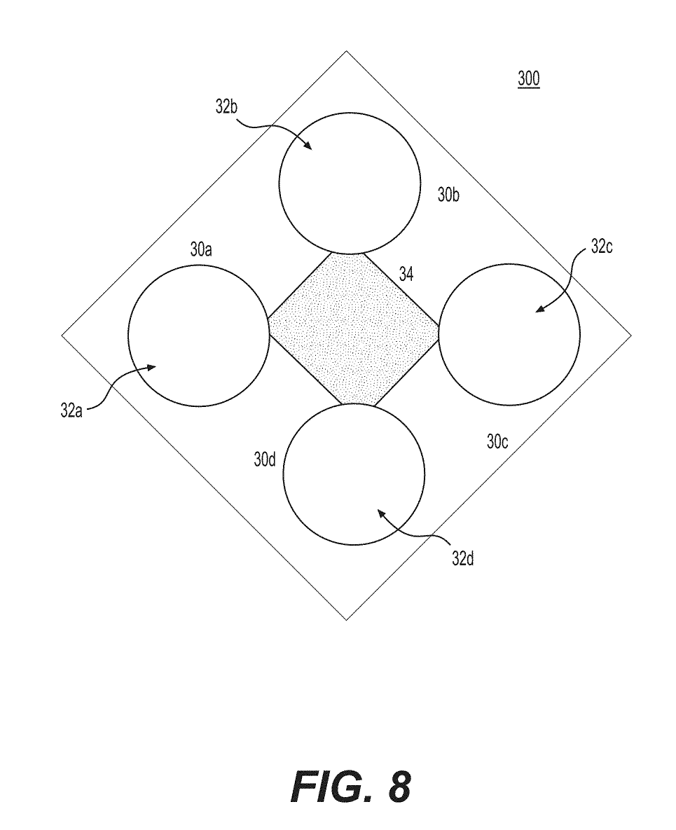

FIG. 8 shows a front view of a third embodiment of the present invention that embodies four channel optics. In FIG. 8 which shows a front view of the instrument 300, each channel 30a-30d consists of a filter structure 32a-32d comprising one or more dielectric filters and an imaging lens system (not shown), but like the second embodiment uses only a single imaging detector 34. In this embodiment, four different spectral regions can be viewed on the single detector 34. To direct the four spectral regions onto the single detector 34, one implementation would be to use four (4) mirrors similar to those in the second embodiment (see FIG. 7), one for each channel 30a-30d to direct the light onto the detector 34.

FIG. 8 represents a four-channel device that by careful use of folding mirrors can place four separate TFIS images on the same detector. It should be noted that one of the possible uses of these devices is to view the earth from very small satellite buses where space and weight is at a premium. The four channel TFIS in FIG. 8 can fit into a 10×10 cm CubeSat configuration; with one-inch optics, this implementation has been calculated to provide sufficient sensitivity to make useful measurements of fluorescence to monitor vegetation health.

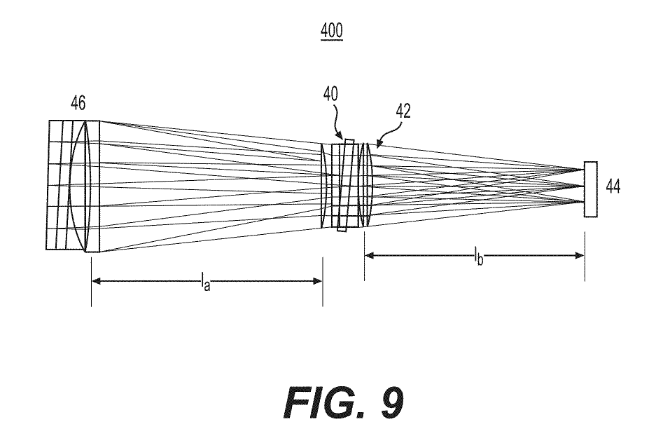

FIG. 9 shows a further embodiment of the present invention that incorporates a high resolution Fabry-Perot etalon (FPI) to the system. In this embodiment, the instrument 400 incorporates at least a filter structure 40 that consists of one or more dielectric filters, an imaging lens system 42, an imaging detector 44 placed at the focal length FL of the lens system, and the high resolution Fabry-Perot etalon 46. The etalon 46 is placed at the front end of the optics and is tilted at an angle that is less than the angle of the filter structure 40 that follows along the optical path. The filter structure 40 is in a more divergent portion of the light beam to compensate for the higher index of refraction of the filter structure 40. The combined fringe patterns have peak transmissions that are coincident when focused on the detector 44. In this embodiment, the spectral resolution of the system can be very high.

In order to compensate for the fact that the filter spacer and the FPI spacer have different indices of refraction, the divergence and tilt angles of the FPI and filter structure must satisfy the condition that lambda FPI=lambda TFIS. That is achieved when the angles satisfy the condition that

$$\frac{{θ}_{TFIS}}{{μ}_{TFIS}} = \frac{{θ}_{FPI}}{{μ}_{FPI}}$$

and the divergence of the beams of light at the two must satisfy the condition

$$\frac{{Ω}_{TFIS}}{{μ}_{TFIS}} = \frac{{Ω}_{FPI}}{{μ}_{FPI}} .$$

Since etendue must be conserved, the optics must be added in general to increase the divergence of the beams in the high index filter section.

FIG. 9 represents a schematic of such a high-resolution spectrometer. In such an optical system, the optics on the left focuses the light passing through the Fabry-Perot etalon 46 at a distance L and the next optic implemented in the filter structure 40 at a distance from the first of lₐ=L·(μ_{FPI}/μ_{Filter}) collimates the beam. The collimated beam passes through the tilted filter structure 40, which is tilted at

$${θ}_{TFIS} = \frac{{μ}_{Filter}}{{μ}_{FPI}} {θ}_{FPI} .$$

The final optic implemented by the imaging lens system 42 focuses the combined fringe pattern on the detector 44 with a focal length of l_{b}=L·(μ_{FPI}/μ_{Filter})). These conditions conserve etendue and assure that the FPI and filter peaks are coincident.

The principles for how a spectrum of light is transmitted through an imaging system consisting of a combined dielectric filter tilted at an angle φ₁ and a Fabry-Perot interferometer (FPI) tilted at a different angle φ₂ and azimuth angle Ψ₂ followed by an imaging detector, according to the embodiment of FIG. 9, is an extension of the coupling of an interference grating and a FPI as described in Principals of Optics (Born and Wolf, 1999). In the Principals of Optics, the image of crossed fields produces a spectrum of very high resolution in the FPI direction with the spectrometer acting as filter to separate orders of the FPI. The crossing of a FPI fringe with a Tilted Filter is clearly analogous to the use of a grating to separate orders of the FPI. Hereinbelow, the instrument function and the inversion of the imaged data to determine the spectrum of light that is incident on the optical system will be described.

### The Instrument Function

Consider that a point on an imaging system detector being the image of a point source of light coming from infinity. That set of rays will pass through the plane of a filter or interferometer at an angle given by the equation:

$$Cos ( θ ) = \frac{( - x Sin ( φ ) Cos ( Ψ ) - y Sin ( φ ) Sin ( Ψ ) + {F}_{0} Cos ( φ ) )}{\sqrt{{F}_{o}^{2} + {x}^{2} + {y}^{2}}}$$

where x and y are the positions of pixels on the detector and Fₒ is the focal length of the imaging system and the angles are relative to the axis of tilt. In a dielectric filter the transmitted wavelength depends on the center band wavelength and the angle that the ray passes through the filter:

$${λ}_{θ} = {λ}_{o} \sqrt{1 - \frac{{sin ( θ )}^{2}}{{μ}_{s}^{2}}}$$

and the transmittance for a Lorentzian filter is given by the simple formula

$$T ( θ , λ ) = \frac{{T}_{Filter} {γ}^{2}}{{( λ - {λ}_{{ϑ}_{filter}} )}^{2} + {γ}^{2}}$$

where γ is FWHH/2 of the filter in the units of Δ.

For a Fabry Perot interferometer the equation is somewhat more complex:

$${T}_{fpi} ( {θ}_{fpi} , λ ) = \frac{{( 1 - {R}_{fpi} - {A}_{fpi} )}^{2}}{1 + {R}_{fpi}^{2} - 2 {R}_{fpi} Cos [ \frac{4 π μ t}{{λ}_{ϑ}} ( ( \frac{λ - {λ}_{ϑ}}{{λ}_{ϑ}} ) + Cos ( {θ}_{fpi} ) - 1 ) ]}$$

Here R is etalon reflectivity; A_{fpi} is etalon absorption and θ is the angle that the light ray makes with the normal to the etalon. Generally, the FPI transmission peaks at a set of periodic wavelengths where

$$\frac{2 μ t}{{λ}_{ϑ}} ( ( \frac{{λ}_{n} - {λ}_{{ϑ}_{Filter}}}{{λ}_{{ϑ}_{Filter}}} ) + Cos ( {θ}_{fpi} ) - 1 ) = n$$

$$where Δ {λ}_{n} = {λ}_{n} - {λ}_{{ϑ}_{Filter}} = ( \frac{n}{{M}_{o}} + 1 - Cos ( {θ}_{fpi} ) ) {λ}_{{ϑ}_{Filter}}$$

where n is an integer. Here

$$\frac{2 μ t}{{λ}_{ϑ}}$$

is the order of interference Mₒ. Thus, the combined transmission of the dielectric filter and FPI

$$T ( {ϑ}_{filter} ( {x}_{i} , {y}_{j} ) , {θ}_{fpi} ( {x}_{i} , {y}_{j} ) , λ ) = \frac{{T}_{Filter} {γ}^{2}}{{( λ - {λ}_{{ϑ}_{filter}} )}^{2} + {γ}^{2}} \frac{{( 1 - {R}_{fpi} - {A}_{fpi} )}^{2}}{1 + {R}_{fpi}^{2} - 2 {R}_{fpi} Cos [ \frac{4 π μ t}{{λ}_{ϑ}} ( ( \frac{λ - {λ}_{{ϑ}_{Filter}}}{{λ}_{{ϑ}_{Filter}}} ) + Cos ( {θ}_{fpi} ) - 1 ) ]}$$

The signal reaching each pixel is then the product of the spectral radiance and the complete instrument function.

Signal_{i,j}=A_{telescope}Ωₚᵢₓₑₗ_{_{i,j}}Time∫T(xᵢ,yⱼ,λ)Spec(λ)dλ

There are several ways to invert the signal to get the spectrum.

### Fitting the Spectrum Using a Fourier Series

Taking the basic equation for the signal using the linear L index to replace the i,j indices

S_{L}=A_{telescope}Ωₚᵢₓₑₗ_{_{i,j}}Time∫T(xᵢ,yⱼ,λ)Spec(λ)dλ=∫_{λ}_{₁}^{λ}^{₂}W_{L}(λ)Spec(λ)dλ

Now let W_{L} and Spec be expanded into Fourier Series

$${W}_{L} ( λ ) = {\sum }_{- ∞}^{∞} {A}_{n , L} {e}^{\frac{2 π in λ}{Δ}} where$$

$$Δ = {λ}_{2} - {λ}_{1} and {A}_{n , L} = \frac{1}{Δ} {\int }_{{λ}_{1}}^{{λ}_{2}} {T}_{L} ( ζ ) {e}^{\frac{- 2 π in ζ}{Δ}} d ζ$$

$$Spec ( λ ) = {\sum }_{k = - ∞}^{∞} {B}_{k} {e}^{\frac{2 π ik λ}{Δ}}$$

Since W_{L} and Spec are real, A_{L,-k}=A_{L,k} and B₋ₖ=Bₖ.

Replacing W_{L} and Spec with the two series leads to the equation below:

$${S}_{L} = {\sum }_{n} {\sum }_{k} {B}_{k} {A}_{n , L} {\int }_{{λ}_{1}}^{{λ}_{2}} {e}^{\frac{2 π i ( k + n ) ζ}{Δ}} d ζ = {\sum }_{k = - ∞}^{∞} {B}_{k} {A}_{L , - k} = {B}_{0} {A}_{L , 0} + 2 {\sum }_{1}^{∞} {B}_{k} {A}_{L , k}$$

This is a simple set of linear equations for the Fourier coefficients of spectrum, in matrix form the equations can be written as:

S_{L}=BₖM_{L,k} where M_{L,0}=A_{L,0} and M_{L,k}=2A_{L,k} for k>0

Reducing the Integral to a Sum and Fitting with Continuous Functions

A very interesting property of the FPI is that at high reflectance the transmission peaks are very narrow, that is the finesse is quite high. Under these conditions, the integral for the signal can be carried out analytically, in integrating one order at a time, the integral of an order in the FPI is a simple constant.

$${\int }_{0}^{2 π} \frac{{( 1 - {R}_{fpi} )}^{2}}{1 + {R}_{fpi}^{2} - 2 {R}_{fpi} Cos ( x )} dx = \frac{1 - {R}_{fpi}}{1 + {R}_{fpi}}$$

Thus, assuming that the filter transmission and Spec can be considered to be at best a linear variation over the individual orders, then the signal_{i,j} is a simple sum over the orders where the filter has finite transmission.

$${Signal}_{i , j} = {A}_{telescope} {Ω}_{{pixel}_{i , j}} Time \frac{{( 1 - {R}_{fpi} - {A}_{fpi} )}^{2}}{1 - {R}_{fpi}^{2}} {T}_{Filter} {\sum }_{n} \{ \frac{{γ}^{2} Spec ( {λ}_{n} )}{{( {λ}_{n} - {λ}_{{ϑ}_{Filter}} )}^{2} + {γ}^{2}} \}$$

where

$${λ}_{n} = ( \frac{n}{{M}_{o}} + 2 - Cos ( {θ}_{fpi} ) ) {λ}_{o}$$

will have few or many orders depending on the free spectral range of the interferometer and the width of the filter, generally the number of orders required at each pixel will be about

$${FWHH}_{Filter} ( nm ) \frac{2 μ {t}_{etalon}}{{λ}^{2}} * {N}_{o}$$

where Nₒ is the number of filter width required to have a negligible effect on the sum contributing to the signal_{i,j}.
Approximating the Spectrum with a Set of Continuous Functions

In order to fit the spectrum from the multitude of pixel data, the spectrum should be expressed in as few parameters as possible. One obvious approach is to expand the spectrum in a series of function, orthogonal or not. B-splines are one approach, but starting with the assumption that a set of orthogonal functions Γₙ(λ) are used, that is

$$Spec ( λ ) = {\sum }_{m = 0}^{M} {A}_{M} {Γ}_{M} ( λ )$$

Substituting this expansion into the expression for the signal yields the relation that

$${Signal}_{i , j} = {A}_{telescope} {Ω}_{{pixel}_{i , j}} Time \frac{{( 1 - {R}_{fpi} - A )}^{2}}{1 - {R}_{fpi}^{2}} {T}_{Filter} {\sum }_{n} {\{ \frac{{γ}^{2} {\sum }_{m = 0}^{M} {A}_{m} {Γ}_{m} ( {λ}_{n} )}{{( {λ}_{n} - {λ}_{{ϑ}_{Filter}} )}^{2} + {γ}^{2}} \}}_{i , j}$$

This is a linear set of equations for the expansion coefficients Am

$${Signal}_{i , j} = {\sum }_{m = 0}^{M} {A}_{M} * {M}_{L , m} where$$

$${M}_{L , m} = {A}_{telescope} {Ω}_{pixel} Time \frac{{( 1 - {R}_{fpi} - A )}^{2}}{1 - {R}_{fpi}^{2}} {T}_{Filter} {\sum }_{n = - No}^{n = {N}_{o}} \{ \frac{{γ}^{2} {Γ}_{m} ( {λ}_{n} )}{{( {λ}_{n} - {λ}_{{ϑ}_{{Filter}_{L}}} )}^{2} + {γ}^{2}} \}$$

In practice, the I,j array can be replaced by a linear array of length Nₓ*N_{y} called sub L then the set of equations becomes simpler to handle, that is Signal_{i,j}=S_{L}

$${S}_{L} = {\sum }_{m = 0}^{M} {A}_{M} * {M}_{Lm} where$$

$$Q = {A}_{telescope} {Ω}_{{pixel}_{i , j}} Time \frac{{( 1 - {R}_{fpi} - A )}^{2}}{1 - {R}_{fpi}^{2}} {T}_{Filter}$$

$${M}_{Lm} = Q {\sum }_{n = - No}^{n = {N}_{o}} {\{ \frac{{γ}^{2} {Γ}_{M} ( {λ}_{n} )}{{( {λ}_{n} - {λ}_{{ϑ}_{{Filter}_{L}}} )}^{2} + {γ}^{2}} \}}_{L} where$$

$${λ}_{n} = ( \frac{n}{{M}_{o}} + 2 - Cos ( {θ}_{fpi} ) ) {λ}_{o}$$

Here the λₙ^{L}'s are the wavelength of the center of the FPI orders where the filter has peak transmission on the L^{th} pixel.

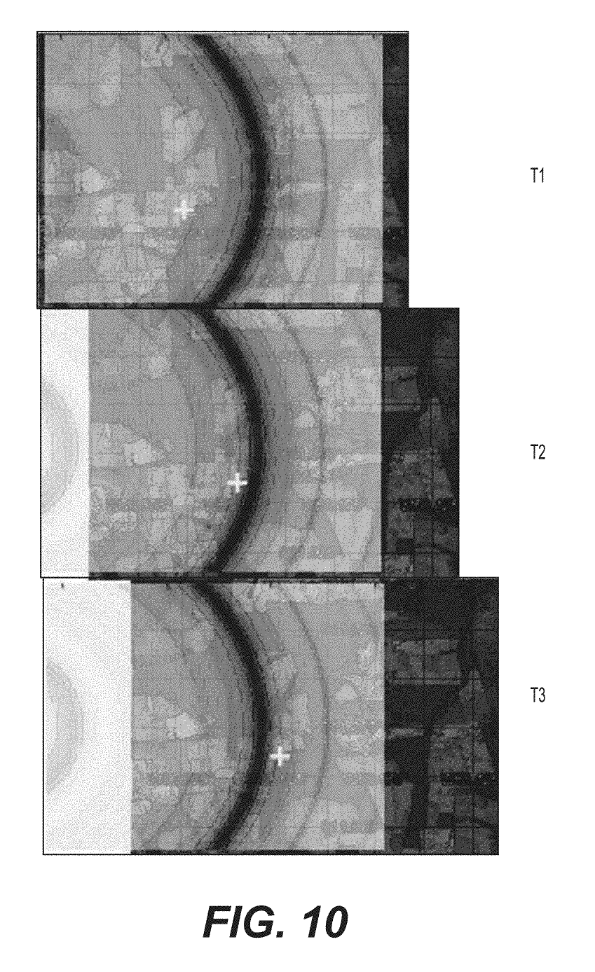

There are many applications of the Tilted Filter Imaging Spectrometer (TFIS). In terms of airborne or space borne imaging of fluorescence and reflectance, FIG. 10 illustrates one of the possible applications of the TFIS to measure the spectrum from every point below a moving platform such as a satellite, aircraft, drone, or even a moving car. FIG. 10 shows how a TFIS spectral imager according to the present invention can sequentially sample the spectrum at times T1-T3 across a scene as the imager moves, as in the case of the imager being mounted on a moving vehicle such as a satellite, airplane, drone or automobile. The white cross in the images represents a single place in the scene. As time progresses from T1 to T3, the entire spectrum is sampled for this individual point. This is happening at each point in the scene and a data cube is being formed as time progresses. The axes of the cube are two geometrical axes and a third spectral axis. As the scene slides over the detector, a point on the ground or scene such as shown with the white cross will cross through the fringe pattern creating as it does a full fringe spectrum. The resulting data set is collected in a three-dimensional data cube. The data cube has two physical axes, the ground locations, and a third which is the spectrum.

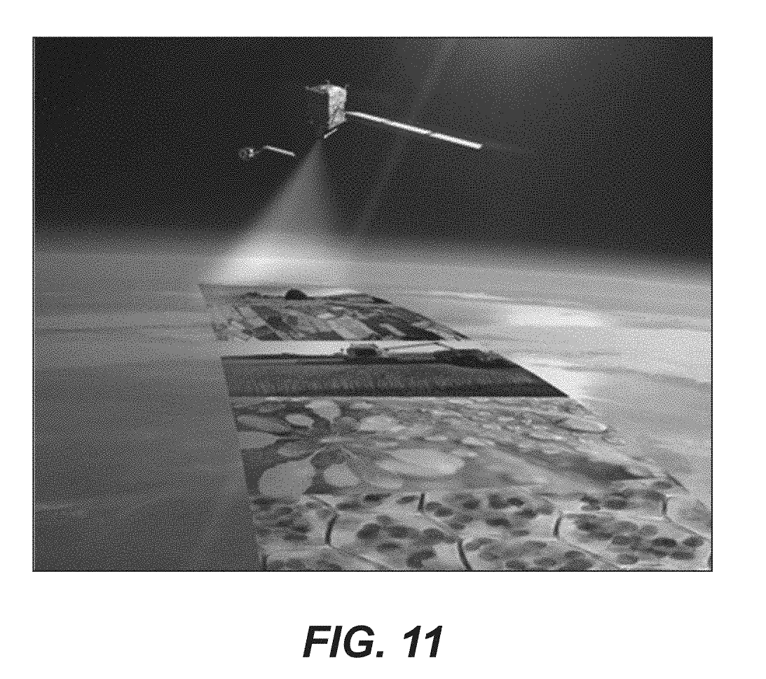

FIG. 11 illustrates how the present invention can be used as a pushbroom spectral scanner in a satellite collecting detailed spectral information which can be analyzed using the FLD technique to produce maps of reflectance and fluorescence of the Earth. These maps can provide important information on the health of vegetation, or they can help to track oil spills in the oceans and inland waterways, and other interesting biologicals such as phytoplankton or plants in the sea.

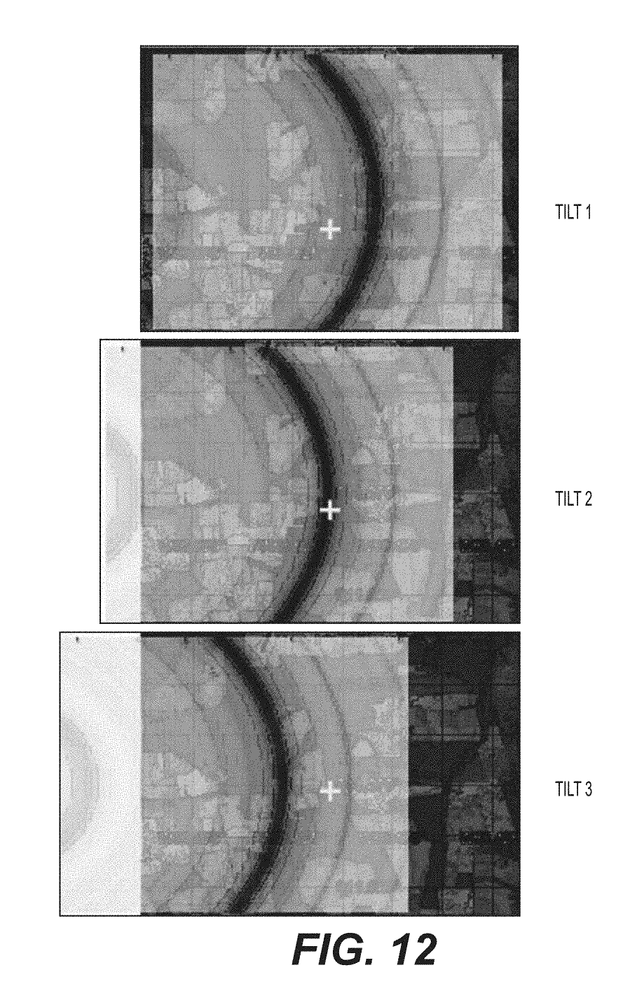

FIG. 12 shows how a stationary scene can be analyzed for the spectral information over a fixed field by taking images of the scene as the filter structure is tilted at angles Tilt 1, Tilt 2 and Tilt 3. As the filter structure is tilted, the spectral pattern is translated across the scene creating a data cube that contains the scene on two axes and the spectral information on the third axis. In FIG. 12, the fringe pattern of the device is scanned across a fixed image as the filter is tilted to produce a spectrum again at each point in the image after data is collected during the scanning period. Here the white cross is a fixed point in the image and one can see how the fringe pattern slides across the image as the filter is tilted. Either moving the pattern or the scene will produce a high-quality spectrum over the spectral region covered by the fringe pattern.

There are many possible variations of this basic instrument depending on the spectral features of interest. The only limitation to the spectral range is when the two polarizations begin to separate, but even in that case a polarizer will maintain the bandpass to higher angles (Swenson 1975, Lissberger 1959). The optics are very small and can be easily combined to provide multiple channels on a single detector.

In the most simplistic form, the reflectance and fluorescence can be resolved from the spectrum using the FLD technique described hereinabove. However, much more accurate inversion techniques have been devised using least squares, singular value decomposition, or principal component analysis (Crisp et al., 2008, Joiner et al., 2011). These techniques could be used to invert the spectra in real time on the moving vehicle to transmit maps of reflectance and fluorescence rather that retrieving the full data cube, thus greatly reducing the information transmitted to the ground. FIG. 11 shows what the transmitted maps would look like after reconstruction.

In other implementations, working in the 600-800 nm region fluorescence from vegetation can be used to monitor the health of crops, forests, and grasslands (Smorenburg et al., 2002) This application can reproduce the results obtained from huge and expensive satellite missions such as GOSAT, OCO, and FLEX (Crisp et al., 2008, Joiner et al., 2011, Frankenberg et al., 2012).

Working in the 400-600 nm region, fluorescence from crude oil floating on sea water, in rivers, and on land (Watson et al., 1974) can help greatly in the remediation of oil contamination. Laser induced fluorescence LIF spectra were compared to solar induced fluorescence SIF to show that SIF (V. Raimondi 1, 2013) can be used to detect crude oil floating on water. The source of the crude oil can also be determined from its fluorescence spectrum.

The 640-720 nm region is where chlorophyll fluorescence is directly linked to physiology of phytoplankton or plants in the sea (Wolanin, 2015). A large percentage of biomass production of carbon is thru phytoplankton growth and death (Roesler et al., 1995). Careful monitoring of the density and health of phytoplankton through their fluorescence is important to understanding the health and productivity of this important source of carbon fixation (Xing, 2007, BABIN, 1996) in the oceans.

The TFIS instrument according to the present invention embodies small, high-throughput, high resolution spectrometers for laboratory or field studies of spectral regions in the visible, near and far infrared. Applications of the present invention further include mineral prospecting with handheld fluorometers using the TFIS, or drones mounting TFIS devices for pushbroom imaging (Watson et al., 1974) as discussed earlier, and in situ measurement of chlorophyll fluorescence in the field and in the laboratory.

While specific embodiments have been described in detail in the foregoing detailed description and illustrated in the accompanying drawings, those with ordinary skill in the art will appreciate that various modifications and alternatives to those details could be developed in light of the overall teachings of the disclosure. Accordingly, the particular arrangements disclosed are meant to be illustrative only and not limiting as to the scope of the invention, which is to be given the full breadth of the appended claims and any and all equivalents thereof.

1. A tilted filter imaging spectrometer, comprising:
at least one dielectric filter;
at least one imaging lens structure; and
an imaging detector operatively positioned at a focal length of the at least one imaging lens structure, wherein
the at least one dielectric filter is operatively positioned at an angle relative to an optical axis of the at least one imaging lens structure,
at least one dielectric filter is further operatively positioned to filter light reflected from an area to be studied therethrough,
the imaging lens structure is operatively positioned to image the filtered light from the at least one dielectric filter to the imaging detector, and
the imaging detector is configured to generate a fluorescence spectrum of the area to be studied via the filtered light detected by the imaging detector.

2. A tilted filter imaging spectrometer according to claim 1, wherein the position angle of the at least one dielectric filter is fixed.

3. A tilted filter imaging spectrometer according to claim 1, wherein the position angle of the at least one dielectric filter is scannably varied to form at least one fringe pattern in response to the filtered light on the detector and that pattern may be scanned across the detector as the filter is tilted.

4. A tilted filter imaging spectrometer according to claim 1, further comprising:
first and second dielectric filters; and
first and second imaging lens structure, wherein
the imaging detector is operatively positioned at a position corresponding to a focal length of the first and second imaging lens structures, and
the first and second dielectric filters are operatively positioned relative to corresponding optical axes of the first and second imaging lens structures, respectively.

5. A tilted filter imaging spectrometer according to claim 1, further comprising:
first, second, third and fourth dielectric filters; and
first, second, third and fourth imaging lens structure, wherein
the imaging detector is operatively positioned at a position corresponding to each focal length of the first, second, third and fourth imaging lens structures, and
the first, second, third and fourth dielectric filters are operatively positioned relative to corresponding optical axes of the first, second, third and fourth imaging lens structures, respectively.

6. A tilted filter imaging spectrometer, comprising:
at least one dielectric filter,
at least one Fabry-Perot Etalon:
at least one imaging lens structure; and
an imaging detector operatively positioned at a focal length of the at least one imaging lens structure, wherein
the at least one Fabry Perot Etalon and at least one dielectric filter that are operatively positioned at angles relative to an optical axis of the at least one imaging lens structure,
the at least one Fabry Perot Etalon and at least one dielectric filter that are further operatively positioned to filter light reflected from an area to be studied therethrough,
the imaging lens structure is operatively positioned to image the filtered light from the at least one Fabry Perot Etalon and at least one dielectric filter to the imaging detector, and
the imaging detector is configured to generate a fluorescence spectrum of the area to be studied via the filtered light detected by the imaging detector.

7. A tilted filter imaging spectrometer according to claim 6, wherein the position angles of at least one Fabry Perot Etalon and at least one dielectric filter are fixed.

8. A tilted filter imaging spectrometer according to claim 6, wherein the position angles of at least one Fabry Perot Etalon and at least one dielectric filter are scanned through different angles, but coordinated so that the system forms at least one of a fixed fringe pattern on the detector and a scanning fringe pattern.

9. A tilted filter imaging spectrometer according to claim 6, further comprising:
first and second dielectric filters;
first and second Fabry Perot Etalons:
first and second imaging lens structure, wherein
the imaging detector is operatively positioned at a position corresponding to a focal length of the first and second imaging lens structures, and
the first and second dielectric filters are operatively positioned relative to corresponding optical axes of the first and second imaging lens structures, respectively.

10. A tilted filter imaging spectrometer according to claim 6, further comprising:
first, second, third and fourth dielectric filters;
first, second, third, and fourth Fabry Perot Etalons; and
first, second, third and fourth imaging lens structure, wherein
the imaging detector is operatively positioned at a position corresponding to each focal length of the first, second, third and fourth imaging lens structures, and
the first, second, third and fourth dielectric filters are operatively positioned relative to corresponding optical axes of the first, second, third and fourth imaging lens structures, respectively.

11. A method for tilted filter imaging, comprising the steps of:
providing a tilted filter imaging spectrometer having at least one dielectric filter, at least one imaging lens structure and an imaging detector operatively positioned at a focal length of the at least one imaging lens structure;
variably positioning the at least one dielectric filter at an angle relative to an optical axis of the at least one imaging lens structure; and
scanning an area to be studied wherein light reflected from the area to be studied is filtered through the at least one dielectric filter;
imaging the filtered light from the at least one dielectric filter via the imaging lens structure to the imaging detector; and
generating a fluorescence spectrum of the area to be studied via the filtered light detected by the imaging detector.

12. A method for tilted filter imaging according to claim 11, further comprising the steps of:
providing a vehicle on which the tilted filter imaging spectrometer is mounted,
wherein the step of scanning the area to be studied includes positioning the vehicle over the area to be studied and variably tilting the at least one dielectric filter.

13. A method for tilted filter imaging according to claim 11, further comprising the steps of:
providing a vehicle on which the tilted filter imaging spectrometer is mounted,
wherein the step of scanning the area to be studied includes moving the vehicle over and across the area to be studied, and
wherein the position angle of the at least one dielectric filter is fixed.

14. A method for tilted filter imaging according to claim 11, wherein the step of scanning an area to be studied wherein light reflected from the area to be studied is filtered through the at least one dielectric filter includes filtering the light reflected from the area to be studied to form at least one fringe pattern on the detector.

15. A method for tilted filter imaging according to claim 11, wherein the step of providing a tilted filter imaging spectrometer includes at least one Fabry-Perot Etalon, and
the at least one Fabry Perot Etalon and at least one dielectric filter that are operatively positioned at angles relative to an optical axis of the at least one imaging lens structure.
